(19) United States
(12) Patent Application Publication
(10) Pub. No.: US 2009/0208758 A1
(43) Pub. Date: Aug. 20, 2009

(54) USE OF AN ADHESION PROMOTER IN A SOLUTION FOR CLEANING THE SURFACE OF A SUBSTRATE BASED ON TPE AND/OR ON PA FOR INCREASING THE ADHESION OF THE SAID SUBSTRATE TO AQUEOUS ADHESIVE BONDS

(75) Inventors: Bruno D'HERBECOURT, Bernay (FR); Rene-Paul EUSTACHE, Combon (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/370,753

(22) Filed: Feb. 13, 2009

Related U.S. Application Data
(60) Provisional application No. 61/042,852, filed on Apr. 7, 2008.

(30) Foreign Application Priority Data
Feb. 15, 2008 (FR) 08.50985

(51) Int. Cl. B32B 27/40; B32B 27/34; B32B 27/36; C09J 5/02; A43B 13/12

(52) U.S. Cl. 428/423.1; 428/474.4; 428/480; 156/308.8; 36/30 R

(57) ABSTRACT

The present invention relates to the use of an adhesion promoter (P) in an effective amount in a cleaning solution (N) in order to form an adhesion promoter cleaning solution (CP), the said solution (CP) being intended to clean the surface of a substrate made of (TPE-PA) material, that is to say of material comprising at least one thermoplastic elastomer (TPE) and/or at least one polyamide (PA) and/or their blend(s), and to increase the adhesion of the said surface to aqueous adhesive bonds, the said adhesion promoter (P) comprising at least one organic molecule comprising at least one isocyanate functional group masked by at least one masking agent.

This application claims benefit, under U.S.C. §119 or §365 of French Application Number FR 08.50985, filed Feb. 15, 2008, and U.S. Provisional Application U.S. 61/042,852, filed Apr. 7, 2008.

### FIELD OF THE INVENTION

The present invention relates to the assembling by adhesive bonding of a first substrate S1 based on thermoplastic elastomer (abbreviated to TPE) and/or on polyamide (PA) homopolymer or copolymer and of a second substrate S2, it being possible for the substrates S1 and S2 to be identical or different in nature.

Subsequently, the term (TPE-PA) is used for these various composition possibilities for the substrate S1 and optionally for the substrate S2, if it is of the same nature. Consequently, (TPE-PA) substrate is understood to mean a substrate which comprises at least one TPE elastomer or else at least one PA, or also a blend of at least one TPE and of at least one PA.

The present invention also relates to a laminated product formed by the assembling of such substrates S1 and S2 using an aqueous adhesive bond (J).

The term aqueous adhesive bond is understood to mean a bond in which primer compositions and/or aqueous adhesive compositions used in successive layers on the (TPE-PA) substrates comprise less than 5% of organic solvents.

The present invention also relates to a process for the manufacture of such a laminate and to its use in the footwear industry, in particular for the assembling of constituent components of soles and very particularly of sports shoe soles.

### PRIOR ART

One of the main areas of expertise of the footwear industry is good control of the adhesive bonding techniques intended to assemble materials of different chemical natures and with different mechanical properties. This expertise is particularly important in the field of sports shoes, where the materials used, in particular for the manufacture of the soles, are frequently novel materials. This requirement is magnified tenfold by the search for performance generally related to the sports shoe.

During the last decade, certain materials based on TPE and/or on PA, such as the materials sold by Arkema under the PEBAX® or Rilsan® trademark, have gradually become established in the field of top of the range footwear, in particular sports shoes, by virtue of their mechanical properties and in particular their exceptional resilience property.

The substrates made of these polyamide-block-polyether copolymer materials, in particular for the manufacture of sports shoe soles, are generally assembled by adhesive bonding to other substrates using an adhesive bond.

Generally, the adhesive bonding of this type of substrate in order to produce a laminate requires at least the following operations:
the cleaning of the surfaces of the substrates to be adhesively bonded, for example with an organic solvent, such as methyl ethyl ketone (MEK), or else with an aqueous-based detergent solution;
the application, generally with a brush, to at least the surface adjoining the substrate S1 (TPE-PA) of a layer of solvent-comprising or aqueous adhesive bond, which can optionally comprise application of a primer, generally a solvent-comprising primer;
placing the two substrates side by side; and
compressing the combination resulting from the preceding step.

During this adhesive bonding, both the primer compositions and the adhesives of the prior art result in evaporation of a large amount of organic solvent. Thus, in the case of the manufacture of a footwear laminate, it is estimated that the average amount of adhesive used for an item of footwear is 5 g and that of primer composition 3 g, and the emission of solvent can be assessed at 2.9 g per item of footwear. If it is accepted that the production unit produces 10 000 items of footwear per day, the total amount of solvent emitted by this unit is 29 kg per day.

The use of an aqueous-based adhesive bond makes it possible to reduce this disadvantage. Unfortunately, the levels of adhesion and the quality of the adhesive bonding, expressed by the peel strength of the substrates based on (TPE-PA) of the systems of the prior art is far from being optimal. Thus, with polyamide-block-polyether copolymer substrates with a Shore D hardness of 55 to 70 on average (for example Pébax® 55-1 or Pébax® 70-1), low peel strengths of between approximately 0.5 and 3 kg/cm are obtained. In point of fact, shoewear manufacturers require a peel strength of greater than 3 kg/cm. In general, aqueous adhesive bonds adhesively bond with great difficulty and, in the majority of cases, they do not even adhesively bond at all to the (TPE-PA) substrates, with which they are incompatible or only very slightly compatible.

Efforts have been made in order to improve the adhesion to (TPE-PA) substrates by incorporation of adhesion-promoting polymers, such as silanes, in the primer formulations or adhesive formulations.

The document WO2007/083072 describes the use of butanediol to activate the adhesion of aqueous adhesive bonds (adhesion primer or adhesive) to thermoplastic polymer supports. However, the activation time only lasts a few minutes after application of the butanediol to the substrate and, when this activation time has expired, the adhesive can no longer react with the substrate. This is why it is preferable to use this type of promoter in combination with a catalyst of amine type, of metal salts type or of organometallic type, as described in the document WO2008/003914. Such a catalyst makes it possible to increase the activation time for the surfaces to be adhesively bonded and gives the assembler greater flexibility in his management of the time for the adhesive bonding, the handling and the conditioning of the components to be assembled. However, this mixture gives adhesion results which vary according to the stiffness of the TPE or PA grades.

There also exist surface treatment techniques, such as: flame brushing, treatment with ultraviolet radiation, corona discharge treatment, plasma treatment, electron beam treatments, and the like.

Other known techniques include chemical treatments, such as, for example, attack on the substrates to be adhesively bonded using acidic or basic solutions or else using special solvents specific to the materials. By way of example, meta-cresol is particularly highly suitable as solvent for polyamide-based polymers.

However, these acidic or basic solutions or these solvents are difficult to handle because of their toxicity, their ecotoxicity and/or their corrosive nature. Their use is thus often limited and requires appropriate protective and application equipment and treatment of the discharges.

Several additional stages are often necessary, such as neutralization of the chemical treatments, rinsing and drying. These stages cause discharges which generate pollution. These additional stages of the assembling process consume energy and reduce the productive output, in particular when the assembling is carried out in a continuous process on industrial lines.

The aim of the present invention is thus to improve the adhesion of materials based on (TPE-PA) to aqueous adhesive bonds while reducing the emissions of volatile organic compounds (VOCs) usually generated during the use of primers and/or adhesives in solution in organic solvents.

Another aim of the present invention is thus to provide a laminate comprising at least one substrate based on (TPE-PA) and a process for the manufacture of such a laminate which overcome the disadvantages of the prior art while avoiding in particular significant release of solvent.

Another aim of the present invention is to provide such a laminate, the peel strength of which is improved even when use is made of (TPE-PA) substrates adhesively bonded by aqueous adhesive bonds.

A further aim of the present invention is to increase the level of adhesion of the (TPE-PA) materials without detrimentally affecting their mechanical properties. Another aim of the present invention is to improve the resistance to ageing of this adhesion.

### SUMMARY OF THE INVENTION

A subject-matter of the present invention is thus the use of an adhesion promoter (P) incorporated in an effective amount in a standard cleaning solution (N) which is not very toxic and not very ecotoxic, for example methyl ethyl ketone. The said cleaning solution is intended for the cleaning of the surface of a substrate made of (TPE-PA) material, that is to say of material comprising at least one thermoplastic elastomer (TPE) and/or at least one polyamide (PA) and/or their blend, and it enhances the adhesion of the said material to aqueous adhesive bonds. This thus makes it possible to avoid the use of primers and/or of adhesives based on solvents. The said adhesion promoter (P) according to the invention comprises at least one organic molecule comprising isocyanate groups masked by at least one masking agent.

### DETAILED DESCRIPTION OF THE INVENTION

Use is made, by the present invention, of an adhesion promoter in a solution for cleaning a surface of a substrate S1 based on (TPE-PA) which makes it possible to increase the adhesion of the said surface to any substrate S2, in particular via an aqueous adhesive bond.

1—Substrate S1

The materials (TPE-PA) of the substrate S1 according to the invention comprise at least one thermoplastic elastomer (TPE) and/or at least one polyamide (PA) and/or a blend of at least one TPE and of at least one PA.

The term “thermoplastic elastomer (TPE) polymer” is understood to mean a block copolymer comprising an alternation of “hard” or “rigid” blocks or segments and of “soft” or “flexible” blocks or segments.

Mention may be made, as an example of copolymer comprising hard blocks and comprising soft blocks, of respectively (a) copolymers comprising polyester blocks and polyether blocks (also known as COPEs or copolyetheresters), (b) copolymers comprising polyurethane blocks and polyether or polyester blocks (also known as TPUs, abbreviation for thermoplastic polyurethanes) and (c) copolymers comprising polyamide blocks and polyether blocks (also known as PEBAs according to the IUPAC).

(a) Regarding the CO PEs or copolyetheresters, these are copolymers comprising polyester blocks and polyether blocks. They are composed of soft polyether blocks resulting from polyether diols and of rigid polyester blocks which result from the reaction of at least one dicarboxylic acid with at least one chain-extending short diol unit. The polyester blocks and the polyether blocks are connected via ester bonds resulting from the reaction of the acid functional groups of the dicarboxylic acid with the OH functional groups of the polyether diol. The linking of the polyethers and diacids forms the soft blocks, whereas the linking of the glycol or of the butanediol with the diacids forms the rigid blocks of the copolyetherester. The chain-extending short diol can be chosen from the group consisting of neopentyl glycol, cyclohexanedimethanol and aliphatic glycols of formula HO(CH₂)ₙOH in which n is an integer having a value from 2 to 10.

Advantageously, the diacids are aromatic dicarboxylic acids having from 8 to 14 carbon atoms. Up to 50 mol % of aromatic dicarboxylic acid can be replaced by at least one other aromatic dicarboxylic acid having from 8 to 14 carbon atoms and/or up to 20 mol % can be replaced by an aliphatic dicarboxylic acid having from 2 to 14 carbon atoms.

Mention may be made, as example of aromatic dicarboxylic acids, of terephthalic acid, isophthalic acid, bibenzoic acid, naphthalenedicarboxylic acid, 4,4′-diphenylenedicarboxylic acid, bis(p-carboxyphenyl)methane, ethylenebis(p-benzoic acid), 1,4-tetramethylenebis(p-oxybenzoic acid), ethylenebis(p-oxybenzoic acid) or 1,3-trimethylenebis(p-oxybenzoic acid).

Mention may be made, as example of glycols, of ethylene glycol, 1,3-trimethylene glycol, 1,4-tetramethylene glycol, 1,6-hexamethylene glycol, 1,3-propylene glycol, 1,8-octamethylene glycol, 1,10-decamethylene glycol and 1,4-cyclohexylenedimethanol. The copolymers comprising polyester blocks and polyether blocks are, for example, copolymers having polyether units derived from polyether diols, such as polyethylene glycol (PEG), polypropylene glycol (PPG), polytrimethylene glycol (PO3G) or polytetramethylene glycol (PTMG), dicarboxylic acid units, such as terephthalic acid, and glycol (ethanediol) or 1,4-butanediol units. Such copolyetheresters are described in Patents EP 402 883 and EP 405 227. These polyetheresters are thermoplastic elastomers. They can comprise plasticizers.

(b) Regarding the TPUs, mention may be made of polyetherurethanes, which result from the condensation of soft polyether blocks which are polyether diols and of rigid polyurethane blocks resulting from the action of at least one diisocyanate which can be chosen from aromatic diisocyanates (e.g., MDT or TDI) and aliphatic diisocyanates (e.g., HDI or hexamethylene diisocyanate) with at least one short diol. The chain-extending short diol can be chosen from the glycols mentioned above in the description of the copolyetheresters. The polyurethane blocks and the polyether blocks are connected via bonds resulting from the reaction of the isocyanate functional groups with the OH functional groups of the polyether diol.

Mention may also be made of the polyesterurethanes which result from the condensation of soft polyester blocks which are polyester diols and of rigid polyurethane blocks resulting from the reaction of at least one diisocyanate with at least one short diol. The polyester diols result from the condensation of dicarboxylic acids advantageously chosen from aliphatic dicarboxylic acids having from 2 to 14 carbon atoms and of glycols which are chain-extending short diols chosen from the glycols mentioned above in the description of the copolyetheresters. They can comprise plasticizers.

(c) Regarding the PEBAs, they result from the polycondensation of polyamide blocks comprising reactive ends with polyether blocks comprising reactive ends, such as, inter alia:

1) polyamide blocks comprising diamine chain ends with polyoxyalkylene blocks comprising dicarboxyl chain ends,

2) polyamide blocks comprising dicarboxyl chain ends with polyoxyalkylene blocks comprising diamine chain ends obtained by cyanoethylation and hydrogenation of aliphatic α,ω-dihydroxylated polyoxyalkylene blocks, known as polyetherdiols,

3) polyamide blocks comprising dicarboxyl chain ends with polyether diols, the products obtained being, in this particular case, polyetheresteramides.

The polyamide blocks comprising dicarboxyl chain ends result, for example, from the condensation of polyamide precursors in the presence of a chain-limiting dicarboxylic acid.

The polyamide blocks comprising diamine chain ends originate, for example, from the condensation of polyamide precursors in the presence of a chain-limiting diamine. The number-average molar mass Mn of the polyamide blocks is between 400 and 20 000 g/mol and preferably between 500 and 10 000 g/mol.

The polymers comprising polyamide blocks and polyether blocks can also comprise randomly distributed units.

Use may advantageously be made of three types of polyamide blocks.

According to a first type, the polyamide blocks originate from the condensation of a dicarboxylic acid, in particular those having from 4 to 20 carbon atoms, preferably those having from 6 to 18 carbon atoms, and of an aliphatic or aromatic diamine, in particular those having from 2 to 20 carbon atoms, preferably those having from 6 to 14 carbon atoms.

Mention may be made, as examples of dicarboxylic acids, of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

Mention may be made, as examples of diamines, of tetramethylenediamine, hexamethylenediamine, 1,10-decamethylenediamine, dodecamethylenediamine, trimethylhexamethylenediamine, isomers of bis(4-aminocyclohexyl)methane (BSACM), bis(3-methyl-4-aminocyclohexyl)methane (BMACM) and 2,2-bis(3-methyl-4-aminocyclohexyl)propane (BMACP), and para-amino-dicyclohexylmethane (PACM), and isophoronediamine (IPDA), 2,6-bis(aminomethyl)norbornane (BAMN) and piperazine (Pip).

Advantageously, PA4.12, PA4.14, PA4.18, PA6.10, PA6.12, PA6.14, PA6.18, PA9.12, PA10.10, PA10.12, PA10.14 and PA10.18 blocks are present.

According to a second type, the polyamide blocks result from the condensation of one or more α,ω-aminocarboxylic acids and/or of one or more lactams having from 6 to 12 carbon atoms in the presence of a dicarboxylic acid having from 4 to 12 carbon atoms or of a diamine.

Mention may be made, as examples of lactams, of caprolactam, oenantholactam and lauryllactamt.

Mention may be made, as examples of α,ω-aminocarboxylic acids, of aminocaproic acid, 7-aminoheptanoic acid, 11-aminoundecanoic acid and 12-aminododecanoic acid.

Advantageously, the polyamide blocks of the second type are made of polyamide 11, of polyamide 12 or of polyamide 6.

According to a third type, the polyamide blocks result from the condensation of at least one α,ω-aminocarboxylic acid (or one lactam), at least one diamine and at least one dicarboxylic acid.

In this case, the polyamide PA blocks are prepared by polycondensation:
of aromatic or linear aliphatic diamine or diamines having X carbon atoms;
of dicarboxylic acid or acids having Y carbon atoms; and
of comonomer or comonomers {Z}, chosen from lactams and α,ω-aminocarboxylic acids having Z carbon atoms and equimolar mixtures of at least one diamine having X1 carbon atoms and of at least one dicarboxylic acid having Y1 carbon atoms (X1, Y1) being different from (X, Y),
the said comonomer or comonomers {Z} being introduced in a proportion by weight ranging up to 50%, preferably up to 20%, more advantageously still up to 10%, with respect to the combined polyamide precursor monomers;
in the presence of a chain-limiting agent chosen from dicarboxylic acids.

Use is advantageously made, as chain-limiting agent, of the dicarboxylic acid having Y carbon atoms which is introduced in excess with respect to the stoichiometry of the diamine or diamines.

According to an alternative form of this third type, the polyamide blocks result from the condensation of at least two α,ω-aminocarboxylic acids or of at least two lactams having 6 to 12 carbon atoms or of a lactam and of an aminocarboxylic acid not having the same number of carbon atoms in the possible presence of a chain-limiting agent.

Mention may be made, as an example of aliphatic α,ω-aminocarboxylic acid, of aminocaproic acid, 7-aminoheptanoic acid, 11-aminoundecanoic acid and 12-aminododecanoic acid.

Mention may be made, as an example of lactam, of caprolactam, oenantholactam and lauryllactam.

Mention may be made, as an example of aliphatic diamines, of hexamethylenediamine, dodecamethylenediamine and trimethylhexamethylenediamine.

Mention may be made, as an example of cycloaliphatic diacids, of 1,4-cyclohexanedicarboxylic acid.

Mention may be made, as an example of aliphatic diacids, of butanedioic acid, adipic acid, azelaic acid, suberic acid, sebacic acid, dodecanedicarboxylic acid, dimerized fatty acids (these dimerized fatty acids preferably have a dimer content of at least 98%; preferably, they are hydrogenated; they are sold under the “Pripol” trademark by “Unichema” or under the Empol trademark by Henkel) and polyoxyalkylene-α,ω-diacids.

Mention may be made, as an example of aromatic diacids, of terephthalic acid (T) and isophthalic acid (I).

Mention may be made, as an example of cycloaliphatic diamines, of isomers of bis(4-aminocyclohexyl)methane (BACM), bis(3-methyl-4-aminocyclohexyl)methane (BMACM), and 2,2-bis(3-methyl-4-aminocyclohexyl)propane (BMACP), and para-amino-dicyclohexylmethane (PACM). The other diamines commonly used can be isophoronediamine (IPDA), 2,6-bis(aminomethyl)norbornane (BAMN) and piperazine.

Mention may be made, as examples of polyamide blocks of the third type, of the following:
6.6/6, in which 6.6 denotes hexamethylenediamine units condensed with adipic acid. 6 denotes units resulting from the condensation of caprolactam.
6.6/Pip.10/12, in which 6.6 denotes hexamethylenediamine units condensed with adipic acid. Pip.10 denotes units resulting from the condensation of piperazine and sebacic acid. 12 denotes units resulting from the condensation of lauryllactam.

The proportions by weight are respectively 25 to 35/20 to 30/20 to 30, the total being 80, and advantageously 30 to 35/22 to 27/22 to 27, the total being 80. For example, the proportions 32/24/24 result in a melting point of 122 to 137° C.
6.6/6.10/11/12, in which 6.6 denotes hexamethylenediamine condensed with adipic acid. 6.10 denotes hexamethylenediamine condensed with sebacic acid. 11 denotes units resulting from the condensation of aminoundecanoic acid. 12 denotes units resulting from the condensation of lauryllactam.

The proportions by weight are respectively 10 to 20/15 to 25/10 to 20/15 to 25, the total being 70, and advantageously 12 to 16/18 to 25/12 to 16/18 to 25, the total being 70.

For example, the proportions 14/21/14/21 result in a melting point of 119 to 131° C.

The polyether blocks can represent 5 to 85% by weight of the copolymer comprising polyamide blocks and polyether blocks. The mass Mn of the polyether blocks is between 100 and 6000 g/mol and preferably between 200 and 3000 g/mol.

The polyether blocks are composed of alkylene oxide units. These units can, for example, be ethylene oxide units, propylene oxide units or tetrahydrofuran units (which result in polytetramethylene glycol linkages). Use is thus made of PEG (polyethylene glycol) blocks, that is to say those composed of ethylene oxide units, PPG (propylene glycol) blocks, that is to say those composed of propylene oxide units, PO3G (polytrimethylene glycol) blocks, that is to say those composed of trimethylene ether units (such copolymers with polytrimethylene ether blocks are described in Patent U.S. Pat. No. 6,590,065), and PTMG blocks, that is to say those composed of tetramethylene glycol units, also known as polytetrahydrofuran units. Use is advantageously made of PEG blocks or blocks obtained by oxyethylation of bisphenols, such as, for example, bisphenol A. The latter products are described in Patent EP 613 919.

The polyether blocks can also be composed of ethoxylated primary amines. Use is also advantageously made of these blocks. Mention may be made, as example of ethoxylated primary amines, of the products of formula:

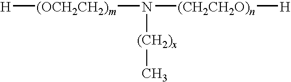

in which m and n are between 1 and 20 and x is between 8 and 18. These products are available commercially under the Noramox® trademark from Ceca and under the Genamin® trademark from Clariant.

The ether units (A2) result, for example, from at least one polyalkylene ether polyol, in particular a polyalkylene ether diol, preferably chosen from polyethylene glycol (PEG), polypropylene glycol (PPG), polytrimethylene glycol (PO3G), polytetramethylene glycol (PTMG) and their blends or their copolymers.

The soft polyether blocks can comprise polyoxyalkylene blocks comprising NH₂ chain ends, it being possible for such blocks to be obtained by a cyanoacetylation of aliphatic α,ω-dihydroxylated polyoxyalkylene blocks, known as polyether diols. Use may more particularly be made of Jeffamines (for example, Jeffamine D400, D2000, ED 2003 and XTJ 542, commercial products from Huntsman. See also Patents JP 2004346274, JP 2004352794 and EP 1 482 011).

The polyether diol blocks axe either used as is and copolycondensed with polyamide blocks comprising carboxyl ends, or they are aminated in order to be converted to polyether diamines and condensed with polyamide blocks comprising carboxyl ends. They can also be mixed with polyamide precursors and a diacid chain-limiting agent in order to form polymers comprising polyamide blocks and polyether blocks which have randomly distributed units.

These polymers can be prepared by the simultaneous reaction of the polyether blocks and of the precursors of the polyamide blocks; preferably, the polycondensation is carried out at a temperature of 180 to 300° C. For example, polyether diol, polyamide precursors and a chain-limiting diacid can be reacted. A polymer is obtained which has essentially polyether blocks and polyamide blocks of highly variable length but also the various reactants which have reacted randomly and which are distributed randomly (statistically) along the polymer chain.

It is also possible to react polyether diamine, polyamide precursors and a chain-limiting diacid. A polymer is obtained which has essentially polyether blocks and polyamide blocks of highly variable length but also the various reactants which have reacted randomly and which are distributed randomly (statistically) along the polymer chain.

However, they can also advantageously be prepared by the condensation reaction of the polyether blocks with the polyamide blocks.

The catalyst is defined as being any product which makes it possible to facilitate the bonding of the polyamide blocks and of the polyether blocks by esterification or by amidation. The esterification catalyst is advantageously a derivative of metal chosen from the group formed by titanium, zirconium and hafnium or also a strong acid, such as phosphoric acid or boric acid. Examples of catalysts are those described in Patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920.

The general method for the preparation in two stages of the PEBA copolymers having ester bonds between the PA blocks and the PE blocks is known and is described, for example, in French Patent FR 2 846 332. The general method for the preparation of the PEBA copolymers of the invention having amide bonds between the PA blocks and the PE blocks is known and described, for example, in European Patent EP 1 482 011.

The reaction for the formation of the PA block usually takes place between 180 and 300° C., preferably from 200 to 290° C., the pressure in the reactor becomes established between 5 and 30 bar and is maintained for approximately 2 to 3 hours. The pressure is slowly reduced by bringing the reactor to atmospheric pressure and then the excess water is distilled off for example over one or two hours.

The polyamide comprising carboxylic acid ends having been prepared, the polyether and a catalyst are subsequently added. The polyether can be added one or more times, and likewise for the catalyst. According to an advantageous form, the polyether is first added and the reaction of the OH ends of the polyether and of the COOH ends of the polyamide begins with formation of ester bonds and removal of water. As much of the water as possible is removed from the reaction medium by distillation and then the catalyst is introduced, in order to complete the bonding of the polyamide blocks and of the polyether blocks. This second stage is carried out with stirring, preferably under a vacuum of at least 6 mmHg (800 Pa), at a temperature such that the reactants and the copolymers obtained are in the molten state. By way of example, this temperature can be between 100 and 400° C. and generally 200 and 300° C. The reaction is monitored by the measurement of the torsional moment exerted by the molten polymer on the stirrer or by the measurement of the electrical power consigned by the stirrer. The end of the reaction is determined by the value of the target moment or of the target power.

During the synthesis, it is also possible to add, at the moment judged the most opportune, one or more molecules used as antioxidant, for example Irganox® 1010 or Irganox® 245.

As regards the preparation of the copolymers comprising polyamide blocks and polyether blocks, they can be prepared by any means which makes it possible to link together polyamide blocks and polyether blocks. In practice, use is made essentially of two processes, one a “two-stage” process and the other a single-stage process.

In the two-stage process, the polyamide blocks are first manufactured and then, in a second stage, the polyamide blocks and the polyether blocks are linked together. In the single-stage process, the polyamide precursors, the chain-limiting agent and the polyether are mixed; a polymer is then obtained which has essentially polyether blocks and polyamide blocks of highly variable length but also the various reactants which have reacted randomly and which are distributed randomly (statistically) along the polymer chain. Whether this is a single- or two-stage process, it is advantageous to carry it out in the presence of a catalyst. Use may be made of the catalysts described in Patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920, WO 04 037898, EP1 262 527, EP 1 270 211, EP 1 136 512, EP 1 046 675, EP 1 057 870, EP 1 155 065, EP 506 495 and EP 504 058. In the single-stage process, polyamide blocks are also manufactured; this is why it was written, at the beginning of this paragraph, that these copolymers could be prepared by any means for linking together polyamide blocks (PA block) and polyether blocks (PE block).

Advantageously, the PEBA copolymers have PA blocks formed of PA 6, PA 11, PA 12, PA 6.12, PA 6.616, PA 10.10 and PA 6.14 and PE blocks formed of PTMG, PPG, PO3G and PEG.

(d) Regarding the polyamides: These are homopolyamides or copolyamides, in particular random or uniform copolyamides.

According to a first type, the polyamide blocks originate from the condensation of a dicarboxylic acid, in particular those having from 4 to 20 carbon atoms, preferably those having from 6 to 18 carbon atoms, and of an aliphatic or aromatic diamine, in particular those having from 2 to 20 carbon atoms, preferably those having from 6 to 14 carbon atoms.

Mention may be made, as examples of dicarboxylic acids, of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

Mention may be made, as examples of diamines, of tetramethylenediamine, hexamethylenediamine, 1,10-decamethylenediamine, dodecamethylenediamine, trimethylhexamethylenediamine, isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-amino-dicyclohexylmethane (PACM), and isophoronediamine (IPDA), 2,6-bis(aminomethyl)norbornane (BAMN) and piperazine (Pip).

Advantageously, PA4.12, PA4.14, PA4.18, PA6.10, PA6.12, PA6.14, PA6.18, PA9.12, PA10.10, PA10.12, PA10.14 and PA10.18 are present.

According to a second type, the polyamides result from the condensation of one or more α,ω-aminocarboxylic acids and/or of one or more lactams having from 6 to 12 carbon atoms in the presence of a dicarboxylic acid having from 4 to 12 carbon atoms or of a diamine.

Mention may be made, as examples of lactams, of caprolactam, oenantholactam and lauryllactam.

Mention may be made, as examples of α,ω-aminocarboxylic acids, of aminocaproic acid, 7-aminoheptanoic acid, 11-aminoundecanoic acid and 12-aminododecanoic acid.

Advantageously, the polyamides of the second type are made of polyamide 11, of polyamide 12 or of polyamide 6.

According to a third type, the polyamides result from the condensation of at least one α,ω-aminocarboxylic acid (or one lactam), at least one diamine and at least one dicarboxylic acid.

In this case, the polyamides PA are prepared by polycondensation:
of aromatic or linear aliphatic diamine or diamines having X carbon atoms;
of dicarboxylic acid or acids having Y carbon atoms; and
of comonomer or comonomers {Z}, chosen from lactams and α,ω-aminocarboxylic acids having Z carbon atoms and equimolar mixtures of at least one diamine having X1 carbon atoms and of at least one dicarboxylic acid having Y1 carbon atoms (X1, Y1) being different from (X, Y),
the said comonomer or comonomers {Z} being introduced in a proportion by weight ranging up to 50%, preferably up to 20%, more advantageously still up to 10%, with respect to the combined polyamide precursor monomers.

Mention may be made, as an example of aliphatic α,ω-aminocarboxylic acid, of aminocaproic acid, 7-aminoheptanoic acid, 11-aminoundecanoic acid and 12-aminododecanoic acid.

Mention may be made, as an example of lactam, of caprolactam, oenantholactam and lauryllactam.

Mention may be made, as an example of aliphatic diamines, of hexamethylenediamine, dodecamethylenediamine and trimethylhexamethylenediamine.

Mention may be made, as an example of cycloaliphatic diacids, of 1,4-cyclohexanedicarboxylic acid,

Mention may be made, as an example of aliphatic diacids, of butanedioic acid, adipic acid, azelaic acid, suberic acid, sebacic acid, dodecanedicarboxylic acid, dimerized fatty acids (these dimerized fatty acids preferably have a dimer content of at least 98%; preferably, they are hydrogenated; they are sold under the “Pripoi” trademark by “Unichema” or under the Empol trademark by Henkel) and polyoxyalkylene-α,ω-diacids.

Mention may be made, as an example of aromatic diacids, of terephthalic acid (T) and isophthalic acid (I).

Mention may be made, as an example of cycloaliphatic diamines, of isomers of bis(4-aminocyclohexyl)methane (BACM), bis(3-methyl-4-aminocyclohexyl)methane (BMACM), and 2,2-bis(3-methyl-4-aminocyclohexyl)propane (BMACP), and para-amino-dicyclohexylmethane (PACM). The other diamines commonly used can be isophoronediamine (IPDA), 2,6-bis(aminomethyl)norbornane (BAMN) and piperazine.

Mention may be made, as examples of polyamides of the third type, of the following:
PA6.6/6, in which 6.6 denotes hexamethylenediamine units condensed with adipic acid. 6 denotes units resulting from the condensation of caprolactam.
PA6.6/Pip.10/12, in which 6.6 denotes hexamethylenediamine units condensed with adipic acid. Pip.10 denotes units resulting from the condensation of piperazine and sebacic acid. 12 denotes units resulting from the condensation of lauryllactam. The proportions by weight are respectively 25 to 35/20 to 30/20 to 30, the total being 80, and advantageously 30 to 35/22 to 27/22 to 27, the total being 80. For example, the proportions 32/24124 result in a melting point of 122 to 137° C.
PA6.6/6.10/11/12, in which 6.6 denotes hexamethylenediamine condensed with adipic acid. 6.10 denotes hexamethylenediamine condensed with sebacic acid. 11 denotes units resulting from the condensation of aminoundecanoic acid. 12 denotes units resulting from the condensation of lauryllactam. The proportions by weight are respectively 10 to 20/15 to 25/10 to 20/15 to 25, the total being 70, and advantageously 12 to 16/18 to 25/12 to 16/18 to 25, the total being 70. For example, the proportions 14/21/14/21 result in a melting point of 119 to 131° C.

The substrate S1 is chosen from the (TPE-PA)s defined above and/or their blends.

Of course, the substrate S1 can additionally comprise additives, such as catalysts, in particular those based on phosphorus, UV stabilizers, colorants, nucleating agents, plasticizers, agents for improving the impact strength, antioxidants, mould-release agents, treatment or processing adjuvants or auxiliaries, in particular stearates, such as calcium stearate, zinc stearate and magnesium stearate, fatty acids, fatty alcohols, esters of montan ester type, sebacic acid esters, dodecanedioic acid esters, polyolefin waxes, amide waxes, stearamides, such as ethylenebisstearamide (EBS), erucamides or fluorinated additives, in particular of Dyneon Dynamer FX 5914 or FX 5911 type.

2—Substrate S2

The substrate S2 can be identical to or different from the substrate S1.

The substrate S2 is chosen from the TPE/PAs defined above and/or their blend(s), homopolymers and copolymers, such as polyolefins, polyamines, polyesters, polyethers, polyesterethers, polymides, polycarbonates, phenolic resins, crosslinked or noncrosslinked polyurethanes, in particular foams, poly(ethylene/vinyl acetate)s, natural or synthetic elastomers, such as polybutadienes, polyisoprenes, styrene/butadiene/styrenes (SBSs), styrene/butadiene/acrylonitriles (SBNs), polyacrylonitriles, natural or synthetic fabrics, in particular fabrics made of organic polymer fibres, such as fabrics made of polypropylene, polyethylene, polyester, polyvinyl alcohol, polyvinyl acetate, polyvinyl chloride or polyamide fibres, fabrics made of glass fibres or of carbon fibres, and materials such as leather, paper and board.

3—Adhesive Bond (J)

Generally, the substrates (S1) based on (TPE-PA) are assembled by adhesive bonding with other substrates (S2) using an adhesive bond. The adhesive bond can be applied in one or more layers of adhesive(s) with different or the same compositions on at least one of the surfaces of the substrates to be adhesively bonded. The adhesive bond can additionally comprise a first primer layer which improves the wetting of the surfaces with the adhesive. The adhesive and the primer can have more or less similar compositions, the primer generally having a lower viscosity than that of the adhesive. One of the advantages of the invention is that both the adhesion primer(s) and/or the adhesive(s) used are predominantly aqueous.

Regarding the Adhesives Applied to the Substrate(s) Based on (TPE-PA):

The adhesive compositions used are those already well known in the field of adhesive bonding of the various components to form laminates, in particular in sports shoes.

The adhesives employed can be single-component, for example comprising a polymer (functionalized or nonfunctionalized) in dispersion in water. The adhesives can also be multicomponent. They are generally two-component adhesives comprising a first component which can be a functionalized resin (for example hydroxylated, carboxylated, epoxy, amine, amide, and the like) or a nonfunctionalized resin, in dispersion or in solution in an organic solvent and/or in water, and a second component (crosslinking component), such as a solution of isocyanate in an organic solvent or also a pure isocyanate or an isocyanate in dispersion in water. The said second component can comprise a masked isocyanate. In order to limit the emission of solvents, the adhesive bonding method according to the invention preferably uses aqueous solutions.

Of course, other types of aqueous-based adhesive can be used. For example, “contact” adhesives can be used, which act by fusion of two layers in contact.

Regarding the Primers Applied to the Substrate(s) Based on (TPE-PA):

The primer compositions used in the present invention are generally two-component compositions, the first component of which is a resin (functionalized or nonfunctionalized) in solution in an organic solvent or in an aqueous solvent or in dispersion in an aqueous solvent and the second component (crosslinking component) of which, which is added to the first component immediately before use, is an isocyanate or mixture of isocyanates also in solution in an organic solvent or in an aqueous solvent or in dispersion in an aqueous solvent.

According to the solvent composition of these primers, this stage of application of the primer thus more or less involves emissions of organic solvents to the atmosphere. The adhesive bonding method according to the invention thus prefers, here also, aqueous solutions. Of course, any other crosslinking agent can be used, for example hexamethoxymethylmelamine (HMMM), which is appropriate in the case of water-based primers.

4—Cleaning Solutions (C)

The cleaning solutions (C), in which an adhesion promoter (P) according to the invention is incorporated, are those generally used to remove impurities, grease or foreign bodies which might detrimentally affect the adhesion of the primers and/or adhesives to the substrates.

These cleaning solutions can also comprise additives, such as wetting agents or detergents, for promoting the removal of contaminants and/or for improving the wettability of the supports.

Mention may be made, for example, of cleaning solutions based on water, based on aliphatic organic solvents or based on aromatic solvents and their mixtures composed of two or more of the three preceding solvents.

The main groups of solvents are:
water
ketones (e.g.: acetone, methyl ethyl ketone)
alcohols (e.g.: methanol, ethanol, isopropanol, glycols)
esters (e.g.: acetates, agriculturally derived solvents)
ethers (e.g.: ethyl ethers, THF, dioxane)
glycol ethers
aromatic hydrocarbons (benzene, toluene, xylene, cumene)
petroleum solvents (excluding aromatics: alkanes, alkenes)
halogenated hydrocarbons: (chlorinated, brominated or fluorinated)
specific solvents (amines, amides, terpenes).

The organic solvents or the solutions based on water and/or based on organic solvents will be carefully chosen so as to reduce as much as possible the emission of solvents and to reduce the risks related to toxicity and to ecotoxicity. Advantageously, methyl ethyl ketone (MEK) will be chosen as cleaning solvent of the organic type or else an aqueous-based detergent solution (dispersion or emulsion) will be chosen, depending on the compatibility of the promoter. As regards a dispersion in water or an aqueous cleaning emulsion, the adhesion promoter (P) is introduced with additives which facilitate the stability of the dispersion or of the emulsion.

As regards the cleaning process, the latter can be carried out according to techniques commonly used in the field, such as: application with a brush, spraying, dipping, and the like. The preferred technique for the cleaning of a (TPE-PA) substrate is dipping, as it ensures that the effect in promoting surface adhesion by the activator is homogeneous and also that the level of adhesive bonding is uniform. Cleaning by dipping makes it possible to more easily avoid contamination of the substrate by possible impurities. Furthermore, the dipping technique is perfectly suited to continuous adhesive bonding methods on an assembly line. Alternatively, cleaning with a brush or using a cloth can be used but it generates contaminated waste.

The clean surface is subsequently “dried” at a temperature within the range extending from 50° C. to 140° C., in order to be able to directly apply the adhesive bond to the cleaned surface, it being possible for this adhesive bond to comprise, for example, a first layer of primer and a layer of adhesive applied to this first layer of primer.

5—Adhesion Promoter

The adhesion promoter (P) used in the cleaning solution according to the invention comprises at least one organic molecule comprising masked isocyanate functional groups. The isocyanate functional groups are masked by agents known as “masking agents”.

(CP) will denote the cleaning solution which promotes adhesion of the invention, comprising a mixture of cleaning solution (C) and of adhesion promoter (P) according to the invention.

Organic molecule is understood to denote a molecule comprising a saturated or unsaturated and linear, branched or cyclic chain comprising carbons and hydrogens.

Molecule comprising a masked isocyanate functional group(s) is understood to mean a molecule, in particular a polymer, the isocyanate functional groups of which are activated only above a certain temperature. This is because the release of the isocyanate functional groups takes place during a thermally activated chemical reaction, so that, at ambient temperature, no isocyanate functional group is accessible when the adhesion promoter (P) or the cleaning solution (CP) is handled. This state greatly limits the risk of contact of the handlers with isocyanate groups, in comparison with handling operations on formulations comprising free isocyanate functional groups, which are known to be allergenic.

The adhesion promoter (P) according to the invention comprises one or more molecules, in particular polymeric molecules, comprising isocyanate functional groups chosen from at least one of the following chemical formulae: 4,4′-diphenylmethane diisocyanate (MDI), 1,6-hexamethylene diisocyanate (HDI), isophorone diisocyanate (IPDI) and toluene diisocyanate (TDI), and their mixtures.

These functional groups can be combined in the dimer or trimer form or else can be grafted to polymers or oligomers. They are called, for example, TDI prepolymer, HDI trimer or IPDI trimer.

Preference will be given, for their affinity with the TPEs and their reactivity with the available functional groups of the TPEs, to aromatic isocyanate structures, for example of the TDI type or TDI prepolymers.

Mention may be made, among the masking agents, of diethyl malonate (DME), 3,5-dimethylpyrazole (DMP), methyl ethyl ketoxime (MEKO) or caprolactam (ε-CAP).

The choice will preferably be made, among molecules comprising masked isocyanate functional groups, of those masked with 3,5-dimethylpyrazole (DMP) for its low-temperature demasking properties, from 60° C., its stability in solution in conventional cleaning solvents of methyl ethyl ketone (MEK) or isopropanol type, and its low sensitivity to moisture.

These products are commercially available, for example from Baxenden under the name Trixene grades BI, Trixene BI 7641 (TDI prepolymer), BI 7642 (TDI prepolymer), BI 7986 and BI 7987 (HDI trimer).

Surprisingly, an adhesion promoter according to the invention, for example DMP-masked Trixene BI 7641 (TDI prepolymer), remains completely soluble and stable in a large amount of MEK, with which it forms a clear solution, MEK being a conventional cleaning solvent very widely used in the footwear industry.

Of course, these examples of molecules comprising masked isocyanate functional groups are only exemplary embodiments of the present invention. They are only given purely by way of illustration and without limitation. Other molecules comprising masked isocyanate functional groups which are particularly well suited to participating in the composition of the adhesion promoter according to the invention are described in European Patent EP 1 358 242. Among the adhesion promoters according to the invention, some comprise molecules comprising masked isocyanate(s) in solvent, others comprise molecules comprising masked isocyanates in aqueous dispersion.

According to their affinity, the adhesion promoters according to the invention are thus introduced in solution in an organic cleaning solvent or else in dispersion in an aqueous cleaning composition in a proportion of 0.5 to 20% by weight of active material, preferably of 0.5 to 5% by weight of active material or better still of 0.5 to 2% by weight of active material.

As regards an organic solution, the adhesion promoter (P) is dissolved at ambient temperature with stirring until dissolution is complete.

As regards an aqueous cleaning dispersion or an emulsion comprising a continuous aqueous phase, the adhesion promoter (P) is introduced with additives which facilitate the stability of the dispersion or of the emulsion.

The adhesion promoters (P) according to the invention are activated only during the operation of “drying” the cleaning solution (CP), at a temperature within the range extending from 50° C. to 140° C. and preferably extending from 70° C. to 120° C.

After temperature activation, the free isocyanate functional groups react with the chemical functional groups available at the surface of the (TPE-PA) substrates and then with the functional groups of the adhesive bond subsequently applied, thus performing their role of adhesion promoter.

The demasking of the isocyanate functional groups at low temperature (50° C.-140° C.) fits perfectly into industrial adhesive bonding processes and makes it possible to prevent deformations of the components to be adhesively bonded, in particular if the latter are sensitive to dimensional changes as a function of the temperature.

Moreover, the fact of using an adhesion promoter in a cleaning solution, rather than in a primer or an adhesive, exhibits several advantages:

First, by virtue of the present invention, it is not necessary to modify the composition of the primers or adhesives conventionally used. This is because the type of adhesion promoter used according to the invention in an adhesive or a primer would have the effect of unbalancing, in these compositions, the percentage of reactive groups and thus of shifting and reducing the adhesive bonding properties of the primer and of the adhesive. Consequently, this would require reformulation of these primers and adhesives.

Secondly, according to the present invention, only the minimum amount of adhesion promoter (on average 1.8% on a dry basis) necessary to bring about the adhesion-promoting effect is used. On the contrary, using adhesive or primer, the adhesion promoter would have to be added at a level of at least 5% in order to observe an effect on the adhesive bonding of a laminate.

By virtue of the present invention, the adhesion promoter is found on the surface of the (TPE/PA) substrate to be adhesively bonded exactly on the site where its action is necessary and effective directly. Instead of being distributed throughout the thickness of a layer of primer or adhesive, the situation of the adhesion promoter at the surface and thus its action are optimized.

Surprisingly, an adhesion promoting effect is observed at temperatures below those commonly necessary and recommended for the demasking of isocyanate functional groups currently used in high temperature ranges markedly greater than 110-120° C. The adhesion promoter used according to the invention results in satisfactory deblocking of isocyanate functional groups from 50° C. to 70° C. in order to bring about an adhesion-promoting effect. Materials generally liable to be deformed at high temperature can thus be adhesively bonded by virtue of the method of the invention without risk of deformation.

6—Method for the Manufacture of a Laminate

The present invention also relates to a method for the manufacture of a laminate. In accordance with the present invention, the adhesive bonding of the types described of substrates (S1) to substrates (S2) for the manufacture of laminates comprises the stages described below.

According to a first advantageous embodiment in the case where the substrates S1 and S2 are made of (TPE-PA) of the same or different nature, the method for the manufacture of a laminate comprises the stages of:

(a) cleaning the surfaces S1 and S2 with a cleaning solution (CP);

(b) drying and activating (CP) at a temperature within the range extending from 60 to 140° C.;

(c) optional application of a layer of water-based primer to S1 and/or S2;

(d) baking the primer layer(s), if appropriate;

(e) application of at least one layer of water-based adhesive to a surface of at least one of the two substrates and/or to the surface of the primer layer(s) if appropriate deposited beforehand on 81 and/or S2;

(f) baking the layers of adhesives at a temperature of the order of 60° C. to 150° C.;

(g) placing side by side, under hot conditions, the surface comprising the layer of aqueous adhesive of one of the substrates and the surface, comprising or not comprising a layer of adhesive, of the other substrate;

(h) compressing the combination and then removing from the press;

(i) recovering the laminated product.

The pressure applied during the compressing stage is from 1 to 15 kg/cm², preferably 3 to 10 kg/cm².

The compressing can be carried out under a humid atmosphere, the air having a relative humidity RH of greater than 5%, preferably of greater than 10% and better still of greater than 20%.

According to a second advantageous embodiment of the present invention, in the case where S1 is made of (TPE-PA) and S2 is of (TPE-PA) with a different chemical nature, the process for the manufacture of a laminate comprises the stages of:

(a) Cleaning the surface S1 with a cleaning solution (CP).

Cleaning and/or preparation of the substrate S2 which are suited to the nature of the substrate, according to standard techniques known to a person skilled in the art.

(b) Drying S1 and activating (CP) at a temperature within the range extending from 60 to 140° C.

(c) Optional (that is to say, nonessential) application of a layer of aqueous-based primer to S1, followed, if appropriate, by baking this primer.

(d) Application or nonapplication of a layer of appropriate primer to the substrate S2, followed, if appropriate, by baking this primer.

(e) Application of a layer of aqueous-based adhesive to the surface 81 or else to the surface of the primer if appropriate deposited beforehand on S1.

(f) Baking the layer of adhesive at a temperature of the order of 60° C. to 150° C.

(g) Application of a layer of adhesive to the surface of S2 or else to the surface of the primer if appropriate deposited beforehand on S2. This adhesive is essentially aqueous and compatible with the adhesive deposited on the substrate S1. Advantageously, this adhesive is identical to that deposited on the substrate S1.

(h) Baking the adhesive. If it is the same adhesive as that for stage (f), baking is carried out at the same temperature as in (f). If it is another adhesive, the baking temperature depends on the support and on the recommendations of the formulator.

(i) Placing side by side, under hot conditions, the surface comprising the layer of aqueous adhesive deposited on the substrate S1 and the layer of adhesive deposited on the substrate S2.

(j) Compressing the combination and, after removing from the press,

(k) Recovering the laminated product.

The pressure applied during the compressing stage is from 1 to 15 kg/m², preferably 3 to 10 kg/cm².

The compressing can be carried out under a humid atmosphere, the air having a relative humidity RH of greater than 5%, preferably of greater than 10% and better still of greater than 20%.

The presses used in the process of the invention are the presses conventional in the field of the manufacture of laminates.

When applied to the manufacture of laminates, the cleaning operations based on adhesion promoter (CP) on materials of the (TPE-PA) type according to the present invention thus make possible the use of a method which is both:
reliable, making possible improved adhesion of the (TPE-PA)s to aqueous adhesive bonds, and
safe, using a completely aqueous adhesive bond (adhesive and/or primer included).

Specifically, the emission of solvents during the process of the invention is greatly reduced. According to an advantageous embodiment of the invention, the cleaning of the surfaces of the substrates to be adhesively bonded is carried out with an aqueous-based detergent solution, the adhesive used is aqueous, as is the optional adhesion primer used.

### Examples

The examples below illustrate the present invention without limiting the scope thereof. In the examples, unless otherwise indicated, all the percentages and parts are expressed by weight.

Substrates:

MX 1940: Peba of PA12-PTMG type (polyamide 12-polytetramethylene glycol), sold by Arkema under the name “PEBAX® MX 1940”.

5533: Peba of PA12-PTMG type (polyamide 12-polytetramethylene glycol), sold by Arkema under the name “PEBAX® 5533”.

7033: Peba of PA12-PTMG type (polyamide 12-polytetramethylene glycol), sold by Arkema under the name “PEBAX® 7033”.

PEBAX® 7033 is harder than PEBAX® 5533 or PEBAX® MX 1940.

Geometry of the Substrates:

Width: 15 mm

Length: 100 mm

Thickness: 1 mm

In the following examples, the primer layer has a dry thickness (after drying) of 1 to 20 μm and the adhesive layer has a dry thickness of 30 to 50 μm.

Adhesion Promoter:

Trixene BI 7641 (TDI prepolymer-60% solids content by weight)

Cleaning Solution (C):

MEK: methyl ethyl ketone

“Adhesion Promoter Cleaning” Solution (CP):

3 grammes of Trixene BI 7641 (TDI prepolymer-60% solids content by weight) are dissolved with stirring in 97 g of MEK. The CP solution has to be completely colourless after dissolution. The “Adhesion promoter cleaning” solution is abbreviated to CP* in the table.

Primers:

W104: aqueous-based primer sold by Dongsung under the name “AQUACE® W104” (solids content−30 min at 150° C.=40% by weight).

Crosslinking agent ARF-40®, sold by Dongsung (solids content−30 min at 150° C.=83.5% by weight)

Dply 171-2: solvent-based primer sold by Dongsung under the name “D-Ply® 171-2” (solids content−30 min at 150° C.=10% by weight).

Crosslinking agent RFE®, sold by Bayer (solids content−30 min at 150° C.=26.9% by weight)

DPLY 007: Solvent-based primer used for rubber, sold by Dongsung under the name “DPLY 007”.

A second “chlorinated compound” component is added to the DPLY 007 in the promotion of 3 to 5% by weight

Adhesive:

W01: Aqueous-based adhesive, sold by Dongsung under the name “AQUACE® W01” (solids content−30 min at 150° C.=46.9% by weight).

Crosslinking agent ARF-40®, sold by Dongsung.

Equipment:

The tests were carried out using the following equipment:
hydraulic press (8 to 15 kg/cm²);
Heraeus convection oven, the setpoint 70° C., ventilated;
hole punch ISO 34;
pneumatic press for cutting out test specimens.

General Assembling Procedure:

Preparation of the Substrate (S1)
cleaning solution: MEK+3.0% (solids content by weight: 1.8%) of adhesion promoter prepolymer of the DMP-masked TDI type);
cleaning with a rag or dipping a smooth face of the substrate S1;

cleaning time: 3 to 20 s
drying for 5 minutes at temperatures of between 60 and 120° C.;
application of the aqueous W104 primer (+5% ARF-40® crosslinking agent) with a brush;
drying for 5 minutes at 70° C. in a ventilated oven;
cooling for 2 minutes at ambient temperature;
application of the aqueous W01 adhesive (+5% ARF-40® crosslinking agent) with a brush;
drying: 5 minutes at 70° C. in a ventilated oven.

Preparation of the Substrate (S2)

In the case where the substrate S2 is of (TPE-PA) nature and the primary use is aqueous-based, the preparation of the substrate S2 is identical to that of the substrate S1 defined in the preceding paragraph denoted: Preparation of the substrate S1.

In the case where the substrate S2 is of (TPE-PA) nature and the primer used is solvent-based, the preparation of the substrate S2 is described as follows:
cleaning a smooth face of the substrate S2 with the solvent MEK;

cleaning time 3 to 20 s;
drying for 2 minutes at ambient temperature;
application of the Dply 171-2 primer (+5% RFE® crosslinking agent) with a brush;
drying for 5 minutes at 70° C. in a ventilated oven;
cooling for 2 minutes at ambient temperature;
application of the aqueous WO1 adhesive (+5% ARF-40® crosslinking agent) with a brush;
drying for 5 minutes at 70° C. in a ventilated oven

In the case where the substrate S2 is a rubber:

The rubber is sanded down beforehand, the rubber particles are removed with a jet of air and the substrate is subsequently cleaned copiously with MEK and then dried for 5 min at 70° C. in a ventilated oven.

The additivated DPLY 007 primer is applied with a brush and then dried for 5 minutes at 70° C. in a ventilated oven. The remainder of the preparation stages remains unchanged.

Peeling Test

The adhesion of the substrates is directly related to the peel force values.

A peeling test was carried out on the laminates of each of Examples No. 1 to 13 according to Standard ISO 11339, speed 100 mm/minute. The peeling tests are preferably carried out within a period of time of between 2 hours and 48 hours after adhesive bonding.

The results of these tests are given in Table 1.

The results show, whatever the hardness of the PEBAX® used, high peel strengths of much greater than 3 kg/cm by virtue of the process for the manufacture of laminates according to the invention with an adhesion promoter cleaning. The adhesion is optimized, with peel strengths of greater than 8, in particular for the laminates where the two substrates are based on (TPE-PA) and for drying temperatures of the order of 60 to 120° C.

TABLE 1
Tests 1-13

| No. | Support S1 | Cleaning | Primer | Adhesive | Adhesive | Primer |
|---|---|---|---|---|---|---|
| 1 | PEBAX | MEK | AQUACE | AQUACE | AQUACE | DPLY |
| | 5533 | | W104 | W01 | W01 | 171-2 |
| | SP01 | | | | | |
| 2 | PEBAX | MEK | AQUACE | AQUACE | AQUACE | DPLY |
| | MX 1940 | | W104 | W01 | W01 | 171-2 |
| | SP01 | | | | | |
| 3 | PEBAX | MEK | AQUACE | AQUACE | AQUACE | DPLY |
| | 7033 | | W104 | W01 | W01 | 171-2 |
| | SP01 | | | | | |
| 4 | PEBAX | CP* | AQUACE | AQUACE | AQUACE | AQUACE |
| | MX 1940 | | W104 | W01 | W01 | W104 |
| | SP01 | | | | | |
| 5 | PEBAX | CP* | AQUACE | AQUACE | AQUACE | AQUACE |
| | MX 1940 | | W104 | W01 | W01 | W104 |
| | SP01 | | | | | |
| 6 | PEBAX | CP* | AQUACE | AQUACE | AQUACE | AQUACE |
| | MX 1940 | | W104 | W01 | W01 | W104 |
| | SP01 | | | | | |
| 7 | PEBAX | CP* | AQUACE | AQUACE | AQUACE | AQUACE |
| | MX 1940 | | W104 | W01 | W01 | W104 |
| | SP01 | | | | | |
| 8 | PEBAX | CP* | AQUACE | AQUACE | AQUACE | AQUACE |
| | 7033 | | W104 | W01 | W01 | W104 |
| | SP01 | | | | | |
| 9 | PEBAX | CP* | AQUACE | AQUACE | AQUACE | AQUACE |
| | 7033 | | W104 | W01 | W01 | W104 |
| | SP01 | | | | | |
| 10 | PEBAX | CP* | AQUACE | AQUACE | AQUACE | AQUACE |
| | 7033 | | W104 | W01 | W01 | W104 |
| | SP01 | | | | | |
| 9a | PEBAX | CP* | AQUACE | AQUACE | AQUACE | DPLY |
| | 5533 | | W104 | W01 | W01 | 171-2 |
| | SP01 | | | | | |
| 10a | PEBAX | CP* | AQUACE | AQUACE | AQUACE | DPLY |
| | 7033 | | W104 | W01 | W01 | 171-2 |
| | SP01 | | | | | |
| 11 | PEBAX | CP* | AQUACE | AQUACE | AQUACE | AQUACE |
| | 5533 | | W104 | W01 | W01 | W104 |
| | SP01 | | | | | |
| 12 | PEBAX | CP* | AQUACE | AQUACE | AQUACE | DPLY |
| | 5533 | | W104 | W01 | W01 | 007 |
| | SP01 | | | | | |
| 13 | PEBAX | CP* | AQUACE | AQUACE | AQUACE | DPLY |
| | 7033 | | W104 | W01 | W01 | 007 |
| | SP01 | | | | | |

| | | | Temperature of | | |
|---|---|---|---|---|---|
| | | | drying and of | Peeling test | |
| | | Support | activation of (C) | Peel force | |
| No. | Cleaning | S2 | or (CP) in ° C. | kg/cm | Comments |
| 1 | MEK | PEBAX | 20° C. | <3 | Very weak |
| | | 5533SA01 | | | adhesion |
| 2 | MEK | PEBAX | 20° C. | <3 | Very weak |
| | | 5533SA01 | | | adhesion |
| 3 | MEK | PEBAX | 20° C. | <3 | Very weak |
| | | 5533SA01 | | | adhesion |
| 4 | CP* | PEBAX | 60° C. | >5.0 | Uniform |
| | | MX 1940 | | | adhesion |
| | | SP01 | | | |
| 5 | CP* | PEBAX | 70° C. | >7.0 | Uniform |
| | | MX 1940 | | | adhesion |
| | | SP01 | | | |
| 6 | CP* | PEBAX | 80° C. | >8.0 | Uniform |
| | | MX 1940 | | | adhesion |
| | | SP01 | | | |
| 7 | CP* | PEBAX | 90° C. | >9.0 | Uniform |
| | | MX 1940 | | | adhesion |
| | | SP01 | | | |
| 8 | CP* | PEBAX | 90° C. | >8 | Uniform |
| | | 7033SA01 | | | adhesion |
| 9 | CP* | PEBAX | 100° C. | >8 | Uniform |
| | | 7033SA01 | | | adhesion |
| 10 | CP* | PEBAX | 120° C. | >8 | Uniform |
| | | 7033SA01 | | | adhesion |
| 9a | MEK | PEBAX | 100° C. | >8 | Uniform |
| | | 5533SA01 | | | adhesion |
| 10a | MEK | PEBAX | 100° C. | >8 | Uniform |
| | | 5533SA01 | | | adhesion |
| 11 | CP* | PEBAX | 90° C. | >8 | Uniform |
| | | 5533SA01 | | | adhesion |
| 12 | MEK | Rubber | 100° C. | >8 | Delamination |
| | | | | | of the |
| | | | | | rubber |
| 13 | MEK | Rubber | 100° C. | >8 | Delamination |
| | | | | | of the |
| | | | | | rubber |

Ageing Tests

In Examples 14 and 16 according to the invention, substrates S1 respectively made of PEBAX 5533 and PEBAX 7033 are adhesively bonded to a substrate S2 made of rubber, according to the same assembling procedure as that defined above.

In Comparative Examples 15 and 17 (which are not according to the invention), substrates S1 respectively made of PEBAX 5533 and PEBAX 7033 are adhesively bonded to a substrate S2 made of rubber, according to the same procedure, except that the cleaning solution (MEK) does not comprise adhesion promoter according to the invention and that the cleaning stage is followed by a stage of activation by a 1,3-butanediol/n-butanol mixture with a 70/30 ratio by volume (abbreviated to bb* in the table).

A peeling test is carried out on a portion of the laminates of each of Examples No. 14 to 17 according to Standard ISO 11339, speed 100 mm/minute. These peeling tests are carried out within a period of time of 12 hours after adhesive bonding (before ageing).

An ageing test is carried out on the other portion of the laminates of each of Tests No. 14 to 17 within a period of time of 12 hours after adhesive bonding.

Ageing test: each of the laminates is placed in an oven at 70° C. and with a degree of humidity of 50% for 5 days.

At the end of these 5 days, a peeling test according to Standard ISO 11339 is carried out on these laminates which have been subjected to ageing.

The results of measurements of the peel forces before ageing and after ageing are summarized in Table 2:

TABLE 2
Tests 14-17

| No. | Support S1 | Cleaning | Activation | Primer | Adhesive | Adhesive | Primer |
|---|---|---|---|---|---|---|---|
| 14 | PEBAX | CP* | | AQUACE | AQUACE | AQUACE | DPLY |
| | 7033 | | | W104 | W01 | W01 | 007 |
| | SP01 | | | | | | |
| 15 | PEBAX | MEK | bb* | AQUACE | AQUACE | AQUACE | DPLY |
| | 7033 | | | W104 | W01 | W01 | 007 |
| | SP01 | | | | | | |
| 16 | PEBAX | CP* | | AQUACE | AQUACE | AQUACE | DPLY |
| | 5533 | | | W104 | W01 | W01 | 007 |
| | SP01 | | | | | | |
| 17 | PEBAX | MEK | bb* | AQUACE | AQUACE | AQUACE | DPLY |
| | 5533 | | | W104 | W01 | W01 | 007 |
| | SP01 | | | | | | |

| | | | Temperature of | Peeling test | Peeling test |
|---|---|---|---|---|---|
| | | | drying and of | Peel force | Peel force |
| | | Support | activation of (C) | kg/cm | kg/cm |
| No. | Cleaning | S2 | or (CP) in ° C. | Before ageing | After ageing |
| 14 | MEK | Rubber | 100° C. | 8.5 | 7 |
| | | | | | Delamination |
| | | | | | of the rubber |
| 15 | | | 100° C. | 3.5 | 0.5 |
| 16 | | | 100° C. | 9 | 7.5 |
| | | | | | Delamination |
| | | | | | of the rubber |
| 17 | | | 100° C. | 9 | 5 |
| | | | | | Delamination |
| | | | | | of the rubber |

On comparing Tests 14 and 15, it is noticed that the use according to the invention (Test 14) of an adhesion promoter in the MEK makes it possible to adhesively bond even to hard grades of PEBAX with a peel force of greater than 8 kg/cm, whereas, for Test 15 (not according to the invention), even a stage of activation by a 1,3-butanediol/n-butanol mixture carried out after cleaning with MEK alone gives only a peel force of less than 3.5 kg/cm on the same hard grade of PEBAX.

On comparing Tests 14 and 17, it is noticed that the peel force of the laminates obtained according to the process of the invention (Tests 14 and 16) remains high (at least equal to 7), even after ageing the laminates, and greater than the peel force of Tests 15 and 17, which have not been subjected to cleaning with a solution of adhesion promoter in the MEK.

In conclusion, the use of an adhesion promoter according to the invention makes it possible to enhance the adhesion of TPE-PA materials, even on the hardest grades, and the adhesion obtained with aqueous adhesive bonds is more stable than with the adhesive bonding techniques of the prior art on TPE-PA.

1. A treated substrate comprising a substrate having directly applied on at least one surface an adhesion promoter cleaning solution (CP), wherein said substrate (S) is a (TPE-PA) material comprising at least one thermoplastic elastomer (TPE) and/or at least one polyamide (PA) and/or their blend(s), wherein said adhesion promoter cleaning solution comprises an effective amount of an adhesion promoter (P) in a cleaning solution (C), said adhesion promoter (P) comprising at least one organic molecule comprising at least one isocyanate functional group masked by at least one masking agent.

2. The treated substrate of claim 1 wherein said adhesion promoter cleaning solution (CP) has a content of adhesion promoter (P) of from 0.5 to 20% by weight of active material, based on the total weight of the cleaning solution (CP).

3. The treated substrate of claim 2, wherein said adhesion promoter cleaning solution (CP) has a content of adhesion promoter (P) of from 0.5 to 2% by weight of active material, based on the total weight of the cleaning solution (CP).

4. The treated substrate of claim 1, wherein said adhesion promoter (P) comprises at least one of the following organic molecules: 4,4′-diphenylmethane diisocyanate (MDI), 1,6-hexamethylene diisocyanate (HDI), isophorone diisocyanate (IPDI) and toluene diisocyanate (TDI), and/or their mixtures.

5. The treated substrate of claim 4, wherein said adhesion promoter (P) is TDI.

6. The treated substrate of claim 1, wherein the said at least one masking agent is chosen from diethyl malonate (DME), 3,5-dimethylpyrazole (DMP), methyl ethyl ketoxime (MEKO), caprolactam (ε-CAP) and/or their mixtures.

7. The treated substrate of claim 6, wherein the said at least one masking agent is 3,5-dimethylpyrazole.

8. The treated substrate of claim 1, wherein the said substrate comprises at least one TPE select from the group consisting of (a) copolymers comprising polyester blocks and polyether blocks (COPEs or copolyetheresters), (b) copolymers comprising polyurethane blocks and polyether or polyester blocks (TPUs, abbreviation for thermoplastic polyurethanes) and (c) copolymers comprising polyamide blocks and polyether blocks (PEBAs) and mixtures thereof.

9. The treated substrate of claim 1, wherein the said adhesion promoter is in solution in methyl ethyl ketone or else in solution or in dispersion in an aqueous solution.

10. A laminated product, comprising a first substrate (S1) and a second substrate (S2) adhering to one another by means of an aqueous adhesive bond (J), the surface of at least one of the first and of the second substrate comprising at least one adhesion promoter (P) comprising at least one organic molecule comprising at least one isocyanate functional group masked by at least one masking agent, wherein the substrate (S1) is a (TPE-PA) material comprising at least one thermoplastic elastomer (TPE) and/or at least one polyamide (PA) and/or their blend(s).

11. The laminated product of claim 10, wherein S1 and S2 are the same.

12. The laminated product of claim 10, wherein the material of the substrate S1 and the material of the substrate S2 are different in nature, S2 being chosen from TPEs, homopolymers and copolymers, such as polyolefins, polyamines, polyesters, polyethers, polyesterethers, polyimides, polycarbonates, phenolic resins, crosslinked or noncrosslinked polyurethanes, in particular in the foam form, poly(ethylene/vinyl acetate)s, natural or synthetic elastomers, such as polybutadienes, polyisoprenes, styrene/butadiene/styrenes (SBSs), styrene/butadiene/acrylonitriles (SBNs), polyacrylonitriles, natural or synthetic fabrics, in particular fabrics made of organic polymer fibres, such as fabrics made of polypropylene, polyethylene, polyester, polyvinyl alcohol, polyvinyl acetate, polyvinyl chloride or polyamide fibres, fabrics made of glass fibres or of carbon fibres, and materials such as leather, paper and board.

13. The laminated product of claim 10, wherein said product is a footwear sole,

14. The laminated product of claim 10, wherein said aqueous adhesive bond comprises at least one layer of aqueous primer and/or at least one layer of aqueous adhesive.

15. The laminated product of claim 14 wherein said adhesive and/or the said primer are of two-component nature:
a first component comprising a functionalized or nonfunctionalized resin in solution in water or in dispersion in water, and
a second component comprising a crosslinking agent, such as an isocyanate, which is pure or in solution in a solvent or in dispersion in water.

16. The laminated product of claim 15, wherein said second component comprises a masked isocyanate

17. A method for assembling, by adhesive bonding, two substrates S1 and S2 by means of an aqueous adhesive bond (J), at least one of the said two substrates being made of (TPE-PA) material comprising at least one thermoplastic elastomer TPE and/or at least one polyamide PA, the said method comprising the steps of:
(a) cleaning the surface of the (TPE-PA) substrate(s) with a cleaning solution comprising an adhesion promoter (P) comprising at least one organic molecule comprising at least one isocyanate functional group masked by at least one masking agent;
(b) applying an aqueous adhesive bond to a surface of at least one of the two substrates;
(c) placing side by side the surface comprising the aqueous adhesive bond (J) of one of the substrates and a surface of the other substrates in order to form a combination comprising the two substrates with the aqueous adhesive bond between them;
(d) compressing the combination in a press;
(e) removing the combination from the press;
(e) recovering the combination in the form of a laminated product.
